(19) United States
(12) Patent Application Publication
(10) Pub. No.: US 2009/0237517 A1
(43) Pub. Date: Sep. 24, 2009

(54) Optical module, camera, and mobile terminal device

(75) Inventors: Sio Kuan Lam, Sheung Shui (HK); Kin Ming Fan, Ma Wan (HK); Tiegang Liu, HuNan Province (CN); Wing Ming Fan, Sheung Shui (HK)

Correspondence Address: BERKELEY LAW & TECHNOLOGY GROUP, LLP, 17933 NW Evergreen Parkway, Suite 250, BEAVERTON, OR, 97006, US

(73) Assignee: Hong Kong Applied Science and Technology Research Institute Co., Ltd., New Territories (CN)

(21) Appl. No.: 12/383,411

(22) Filed: Mar. 24, 2009

(30) Foreign Application Priority Data
Mar. 24, 2008 (CN) CN 200810090504.1

(51) Int. Cl. G02B 27/64; H04N 5/228

(52) U.S. Cl. 348/208.11; 359/557; 348/E05.031

(57) ABSTRACT

An optical module, a camera, and a mobile terminal device are provided. The optical module includes a lens unit, a lens driving unit, a driving control unit, and a vibration sensing unit. The vibration sensing unit is configured to detect vibration/shaking of the optical module, the camera, or the mobile terminal device and transmit a detected signal to the driving control unit. The driving control unit generates a corresponding vibration/shaking compensation signal according to the detected signal of the vibration sensor, and performs a vibration/shaking compensation movement by driving the lens with the lens driving unit. The optical module is applied in the camera and the mobile terminal device. The present invention has not only an auto-focusing function, but also an added anti-vibration function, so as to overcome influences on image degradation resulted from vibration/shaking of the optical module, the camera, or the mobile terminal device.

### BACKGROUND OF THE INVENTION

1. Field of Invention

The present invention relates to an optical system, and more particularly to an optical module, a camera, and a mobile terminal device applying the optical module.

2. Related Art

With the continuous development of digital technology, the performance of a camera is increasingly improved. In order to form a clear image of an object in a camera, a lens actuator in the camera is generally used to control a position of the lens or move the lens to achieve a good focusing. At present, the above process is usually automatically implemented by a control circuit. Thereby, such a function is called auto-focusing, the key point of which is to control the lens to move along a direction of an optical axis of the lens, so as to change a distance between the lens and a camera sensor.

Popular digital cameras nowadays are usually very sophisticated, and can be used in various occasions. Generally, no corresponding fixing device such as a tripod is provided for fixation in picture-shooting, such that the influences of hand vibration/shaking of a user when shooting a picture become inevitable, and the definition of a shot image is influenced. Though the auto-focusing function meets the demand of image definition under most circumstances, in some occasions that a high-definition image is required, only the auto-focusing function is not enough. Therefore, it is necessary to deal with hand vibration/shaking in picture-shooting to obtain a higher definition.

### SUMMARY OF THE INVENTION

Accordingly, the present invention is related to an optical module, a camera, and a mobile terminal device, capable of providing vibration/shaking compensation to obtain a higher image definition.

In order to solve the above technical problem, the following technical solutions are described in the present embodiments of the invention.

An optical module includes a lens unit, a lens driving unit and an image sensing unit. The lens unit projects an image on the image sensing unit and the lens driving unit for driving the lens unit adapted for tilting motion and/or rotating motion and translating motion in response to the vibration/shaking of the optical module to eliminate or mitigate the negative imaging effect of the vibration/shaking of the optical module. The optical module may further comprise a driving control unit and a vibration sensor. The vibration sensing unit is configured to detect vibration/shaking of the optical module, a camera, or a mobile terminal device and transmit a detected signal to the driving control unit. The driving control unit generates a corresponding vibration/shaking compensation signal according to the detected signal of the vibration sensing unit, and performs a vibration/shaking compensation movement by driving the lens unit with the lens driving unit. The optical module also includes a spacer attached to said lens driving unit and placed surround or on top of said image sensing unit.

The lens driving unit can be a piezoelectric type actuator, an electro-active polymer type actuator, or a voice coil motor type actuator. The lens driving unit can further comprise various combinations of piezoelectric actuator, electro-active polymer actuator, and voice coil motor actuator.

The vibration/shaking compensation movement includes a titling motion, translating motion or rotating motion relative to a direction of an optical axis of the lens unit.

A camera includes an optical module. The optical module includes a lens unit, a lens driving unit and an image sensing unit. The lens unit projects an image on the image sensing unit and the lens driving unit for driving the lens unit adapted for tilting motion and/or rotating motion and translating motion in response to the vibration/shaking of the optical module or the camera to eliminate or mitigate the negative imaging effect of the vibration/shaking of the optical module or the camera. The optical module may further comprise a driving control unit and a vibration sensor. The vibration sensing unit is configured to detect vibration/shaking of the optical module, a camera, or a mobile terminal device and transmit a detected signal to the driving control unit. The driving control unit generates a corresponding vibration/shaking compensation signal according to the detected signal of the vibration sensing unit, and performs a vibration/shaking compensation movement by driving the lens unit with the lens driving unit. The optical module also includes a spacer attached to said lens driving unit and placed surround or on top of said image sensing unit.

In the camera, the lens driving unit can be a piezoelectric type actuator, an electro-active polymer type actuator, or a voice coil motor type actuator. The lens driving unit can further comprise various combinations of piezoelectric actuator, electro-active polymer actuator, and voice coil motor actuator.

In the camera, the vibration/shaking compensation movement includes a titling motion, translating motion or rotating motion relative to a direction of an optical axis of the lens unit.

A mobile terminal device includes a camera module which composes of an optical module. The optical module includes a lens unit, a lens driving unit and an image sensing unit. The lens unit projects an image on the image sensing unit and the lens driving unit for driving the lens unit adapted for tilting motion and/or rotating motion and translating motion in response to the vibration/shaking of the optical module or the mobile terminal device to eliminate or mitigate the negative imaging effect of the vibration/shaking of the optical module or the mobile terminal device. The optical module may further comprise a driving control unit and a vibration sensor. The vibration sensing unit is configured to detect vibration/shaking of the optical module, a camera, or a mobile terminal device and transmit a detected signal to the driving control unit. The driving control unit generates a corresponding vibration/shaking compensation signal according to the detected signal of the vibration sensing unit, and performs a vibration/shaking compensation movement by driving the lens unit with the lens driving unit. The optical module also includes a spacer attached to said lens driving unit and placed surround or on top of said image sensing unit.

In the mobile terminal device, the lens driving unit can be a piezoelectric type actuator, an electro-active polymer type actuator, or a voice coil motor type actuator. The lens driving unit can further comprise various combinations of piezoelectric actuator, electro-active polymer actuator, and voice coil motor actuator.

In the mobile terminal device, the vibration/shaking compensation movement includes a titling motion, translating motion or rotating motion relative to a direction of an optical axis of the lens unit.

Compared with the prior art, the present embodiments of the invention also have the auto-focusing function. Meanwhile, in the present embodiments, vibration/shaking of an optical module, a camera, or a mobile terminal device is detected by a vibration sensing unit, a corresponding compensation signal is computed by the lens driving unit, and a corresponding vibration/shaking compensation movement is performed by driving the lens with the lens driving unit according to the compensation signal, thereby eliminating influences of the vibration/shaking of the lens on the image definition.

### BRIEF DESCRIPTION OF THE DRAWINGS

Embodiments of the invention will become more fully understood from the detailed description given herein below for illustration only, and thus are not limitative of the claimed subject matter, and wherein:

FIG. 1 is a system block diagram of an optical module according to an embodiment of the present invention;

FIG. 2 is an exploded structural view of a camera according to an embodiment of the present invention;

FIG. 3-A is a schematic view of an optical path of lens imaging according to an embodiment of the present invention;

FIG. 3-B is a schematic view of an optical path when the camera vibrates according to the embodiment of the present invention;

FIG. 3-C is a schematic view of an optical path of vibration compensation according to the embodiment of the present invention; and

FIG. 4 is a schematic view of relative positions of image points in FIG. 3 on an image capture face of an image sensor.

### DETAILED DESCRIPTION OF THE INVENTION

Embodiments of the present invention are further illustrated in detail below with the accompanying drawings.

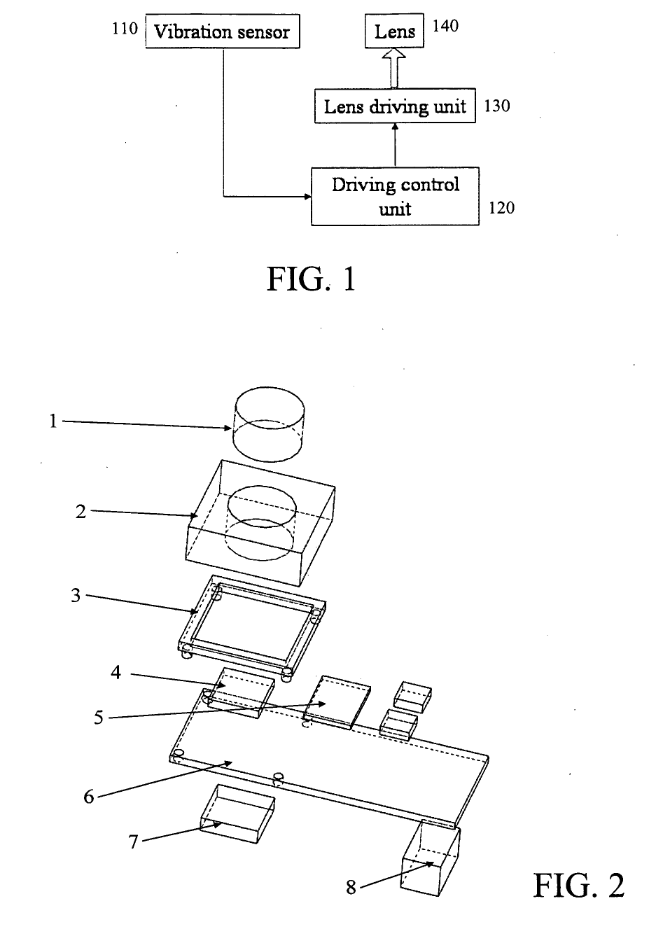

Referring to FIG. 1, in an embodiment of the present invention, an optical module includes a lens unit 140, a lens driving unit 130, a driving control unit 120, and a vibration sensing unit 110. The lens unit 140 is configured to collect optical signals of outside object. The lens driving unit 130 carries the lens unit 140, and is capable of driving the lens unit 140 to perform an up and down, left and right, or forward and backward linear movement or a rotation under the control of a control signal. The lens driving unit 130 can be a piezoelectric type actuator, an electro-active polymer type actuator, or a voice coil motor type actuator. The lens driving unit 130 can further comprise various combinations of piezoelectric actuator, electro-active polymer actuator, and voice coil motor actuator. The lens driving unit 130 drive the lens unit 140 to realize vibration/shaking compensation in various effective vibration compensation manners. The vibration sensing unit 110 detects vibration/shaking of the optical module, or camera, or the mobile terminal device, and transmits a detected signal to the driving control unit. The vibration sensing unit 110 can be a gyroscope or an accelerometer or a combination of gyroscope and accelerometer. The driving control unit is an electronic control device, for example, a micro controller unit (MCU), adapted to compute a corresponding vibration/shaking compensation signal according to the lens vibration/shaking signal detected by the vibration sensor, and then transmit a corresponding control signal so as to control the lens driving unit to drive the lens to perform a corresponding vibration/shaking compensation movement.

By applying the optical module in an optical system, for example, a digital camera, compensation to vibration/shaking is obtained in addition to auto-focusing (generally referring to a forward and backward movement of the lens along an optical axis of the lens) of the optical system, so as to effectively eliminate the influences of the vibration/shaking, and improve the definition of images taken by the optical system.

FIG. 2 shows a structure of a camera according to an embodiment of the present invention. The camera mainly includes a lens unit 1, a lens driving unit 2, a spacer 3, an image sensor 4, a driving control unit 5, a printed circuit board (PCB) 6, a vibration sensing unit 7, and an electronic connector 8. The PCB 6 is used for configuring related circuits, for example, the image sensor 4 for obtaining an optical signal collected by the lens and converting the signal into an electric signal. The position relation of the related circuits on the PCB 6 follows a common electrical principle of PCB component placement, which is well known to those of ordinary skill in the art, and will not be described herein again. The PCB 6 is connected to the other electronic circuit of the application device via an electronic connector 8, and the lens unit 1 is carried on the lens driving unit 2. The lens driving unit 2 is placed that an optical axis of the lens unit passes through the image sensor 4, and the spacing pad 3 is also disposed between the lens driving unit 2 and the PCB 6, so as to provide isolation protection for the image sensor 4.

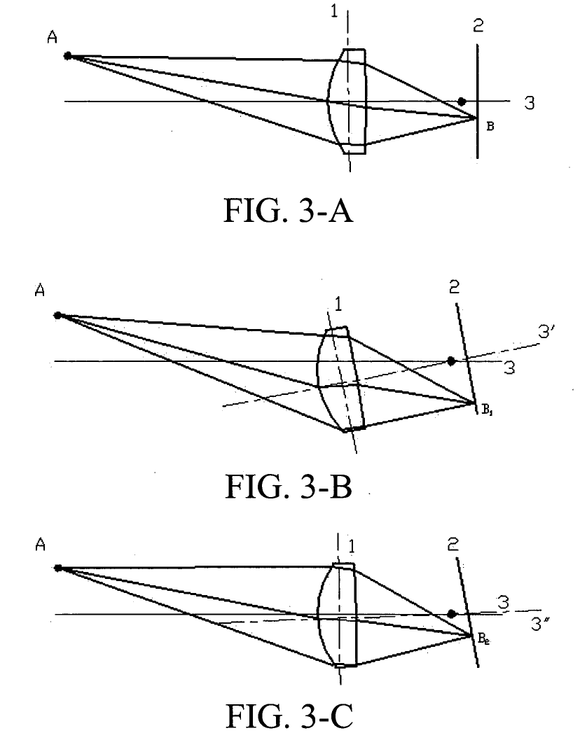

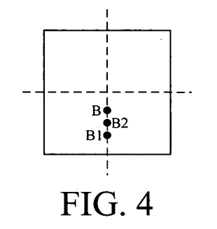

FIGS. 3-A, 3-B, 3-C, and 4 show positions of image points on the imaging plane in different circumstances according to the present invention. In the figures, 1 indicates a lens unit, 2 indicates an image capturing plane of an image sensor, and 3 indicates an optical axis line of the lens unit. It can be seen that in an ideal situation shown in FIG. 3-A, when the lens unit 1 is at an original position denoted by an elliptical solid line, an optical axis of the lens unit 1 is indicated by a horizontal solid line 3, and an object point A is focused at a point B on the image capturing plane 2. However, the camera module or the mobile terminal device tilts due to vibration/shaking, as shown in FIG. 3-B, so that the optical axis 3 tilts to a position indicated by a dashed line 3′, and an imaging point of the object point A on the image capturing plane 2 falls on a point B1, which is different from point B as shown in FIG. 4. If this vibration/shaking occur during exposure period of a picture, the resulting picture will be blurred due to the movement of imaging point from point B to point B1 caused by the vibration/shaking. By performing vibration compensation on the lens unit, the lens unit will be tilted in a controllable manner such that the optical axis 3 of lens unit is recovered to a position indicated by a dashed line 3″, where the distance between B2 to B is much closer than the distance of B1 to B. If the correction magnitude is precisely controlled, the point B2 may return to the point B, so as to fully eliminate the blurring effect of vibration/shaking.

The optical module according to the embodiment of the present invention is capable of performing auto-focus functions by driving the lens unit moving along its optical axis by energizing the said actuators accordingly.

The optical module according to the embodiment of the present invention may not only be applied in a camera, but also in other devices capable of shooting pictures, for example, a mobile terminal device having a camera module. Due to the miniaturization of the components used by the lens driving unit, the optical module is very suitable for use in sophisticated devices like digital cameras and mobile terminals.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical module, comprising
a lens unit,
a lens driving unit,
an image sensing unit,
wherein said lens unit for projecting an image on said image sensing unit and said lens driving unit for driving the said lens unit adapted for tilting motion and/or rotating motion and/or translating motion in response to the vibration/shaking of said optical module to eliminate or mitigate the negative imaging effect of the vibration/shaking of said optical module.

2. The optical module according to claim 1, further comprising a vibration sensing unit, wherein said vibration sensing unit detects the vibration/shaking of said optical module.

3. The optical module according to claim 2, further comprising a driving control unit, wherein said driving control unit generates a corresponding vibration/shaking compensation signal according to the detected signal of said vibration sensing unit and controls said lens driving unit to drive said lens unit.

4. The optical module according to claim 1, further comprising a spacer, wherein said spacer is attached to said lens driving unit and placed surround or on top of said image sensing unit.

5. The optical module according to claim 1, wherein said lens driving unit comprises at least two actuators.

6. The optical module according to claim 5, wherein the actuators comprise various combinations of piezoelectric actuator, electro-active polymer actuator, and voice coil motor actuator.

7. The optical module according to claim 1-6 is capable of performing auto-focus functions by driving the lens unit moving along its optical axis by energizing the said actuators accordingly.

8. A camera, comprising an optical module, wherein said optical module comprises a lens unit, a lens driving unit and an image sensing unit, wherein said lens unit for projecting an image on said image sensing unit and said lens driving unit for driving said lens unit adapted for tilting motion and/or rotating motion and translating motion in response to the vibration/shaking of said optical module or said camera to eliminate or mitigate the negative imaging effect of the vibration/shaking of said optical module or said camera.

9. The camera according to claim 8, further comprising a vibration sensing unit, wherein said vibration sensing unit detects the vibration/shaking of said optical module or said camera.

10. The camera according to claim 8, further comprising a driving control unit, wherein said driving control unit generates a corresponding vibration/shaking compensation signal according to the detected signal of said vibration sensing unit and controls said lens driving unit to drive said lens unit.

11. The camera according to claim 8, further comprising a spacer, wherein said spacer is attached to said lens driving unit and placed surround or on top of said image sensing unit.

12. The camera module according to claim 8, wherein said lens driving unit comprises at least two actuators.

13. The camera module according to claim 12, wherein the actuators comprise various combinations of piezoelectric actuator, electro-active polymer actuator, and voice coil motor actuator.

14. The camera module according to claim 8-13 is capable of performing auto-focus functions by driving the lens unit moving along its optical axis by energizing the said actuators accordingly.

15. A mobile terminal device, comprising an optical module, wherein said optical module comprises a lens unit, a lens driving unit and a image sensing unit, wherein said lens unit for projecting an image on said image sensing unit and said lens driving unit for driving said lens unit adapted for tilting motion and/or rotating motion and translating motion in response to the vibration/shaking of said optical module or said mobile terminal device to eliminate or mitigate the negative imaging effect of the vibration/shaking of said optical module or said mobile terminal device.

16. The mobile terminal device according to claim 15, further comprising a vibration sensing unit, wherein said vibration sensing unit detects the vibration/shaking of said optical module or said mobile terminal device.

17. The mobile terminal device according to claim 15, further comprising a driving control unit, wherein said driving control unit generates a corresponding vibration/shaking compensation signal according to the detected signal of said vibration sensing unit and controls said lens driving unit to drive said lens unit.

18. The mobile terminal device according to claim 15, further comprising a spacer, wherein said spacer is attached to said lens driving unit and placed surround or on top of said image sensing unit.

19. The mobile terminal device according to claim 15, wherein said lens driving unit comprises at least two actuators.

20. The mobile terminal device according to claim 19, wherein the actuators comprise various combinations of piezoelectric actuator, electro-active polymer actuator, and voice coil motor actuator.

21. The mobile terminal device according to claim 15-20 is capable of performing auto-focus functions by driving the lens unit moving along its optical axis by energizing the said actuators accordingly.
